(19) United States
(12) Patent Application Publication
(10) Pub. No.: US 2024/0369914 A1
(43) Pub. Date: Nov. 7, 2024

(54) HEATING A LENS MODULE OF A CAMERA FOR A MOTOR VEHICLE

(71) Applicant: CONNAUGHT ELECTRONICS LTD., Tuam, County Galway (IE)

(72) Inventors: Patrick Young, Tuam (IE); Blain Prendergast, Tuam (IE)

(73) Assignee: CONNAUGHT ELECTRONICS LTD., Tuam, County Galway (IE)

(21) Appl. No.: 18/689,245

(22) PCT Filed: Sep. 6, 2022
(86) PCT No.: PCT/EP2022/074691

§ 371 Date: Mar. 5, 2024

(30) Foreign Application Priority Data
Sep. 7, 2021 (DE) 10 2021 123 051.9

(51) Int. Cl. G03B 17/55; B60R 11/04

(52) U.S. Cl. CPC G03B 17/55; B60R 11/04

(57) ABSTRACT

The present invention relates to a camera for a motor vehicle. The camera includes a lens module, a lens holder body, which is mechanically connected to the lens module, and an electrical heater element for heating the lens module. The heater element is arranged at a surface of the lens holder body facing away from the lens module. The heater element is thermally connected to the lens module via the lens holder body.

The present invention is directed to a camera for a motor vehicle, the camera comprising a lens module, a lens holder body, which is mechanically connected to the lens module, and an electrical heater element for heating the lens module. The invention is further directed to an electronic vehicle guidance system comprising such a camera and to a method for heating a lens module of a camera for a motor vehicle.

Cameras arranged on motor vehicles are known in various configurations. In this context, it is known that cameras are formed and arranged for capturing the environment of the motor vehicle. However, cameras may also be employed for the capturing an interior of the vehicle and may be arranged correspondingly. Thus, the cameras may be exposed to significant temperature fluctuations and/or other environmental conditions. Moreover, the cameras are also exposed to mechanical stress due to the vibrations while the vehicle is moving. Cameras for motor vehicles should therefore be designed to still operate as desired under said conditions and to achieve sufficiently good image quality. The images may then be provided to driver assistance systems or other electronic vehicle guidance system, which may use them as an input for driver assistance or at least partly automatically guiding the vehicle.

One circumstance that may lead to degraded image quality, especially with cameras mounted externally on the vehicle, is when ice builds up on the lens of the camera due to low environmental temperatures.

Document DE 10 2015 116 962 A1 describes a camera for a vehicle with a heating unit for heating a lens of the camera. The heating unit is designed as an elongated wire element, which is guided through an axial channel from the lens to a circuit board, which is arranged axially distant from the lens.

Document DE 10 2015 111 281 A1 describes a camera for a vehicle with an inductive heater for heating the lens. The heater comprises windings surrounding a part of the lens, which may be coated with a ferromagnetic material.

In such known cameras, the heater has to be supplied with electrical energy by an energy source, which is placed at a distance from the heater. The correspondingly required wiring of the heater must therefore be guided from the lens through the camera or lens housing. The wiring is a potential weak spot where the camera can be damaged by external influences or during installation. Furthermore, the wiring makes the assembly more complex and thus more costly and prone to errors.

It is an objective of the present invention to simplify the electrical contacting of a heater element for heating a lens module of a camera for a vehicle.

This objective is achieved by the respective subject matter of the independent claims. Further implementations and preferred embodiments are the subject matter of the dependent claims.

The invention is based on the idea to place the heater element remotely from the actual lens module to be heated, heat a lens holder body, which is attached to the lens module, and transfer the heat via a thermal connection from the heater element via the lens holder body to the lens module and finally to the lens.

According to an aspect of the invention, a camera for a motor vehicle is provided. The camera comprises a lens module, a lens holder body, which is mechanically connected to the lens module, and an electric heater element for heating the lens module. The heater element is arranged at a surface of the lens holder body, wherein the surface faces away from the lens module. The heater element is thermally connected to the lens module via the lens holder body to heat the lens module.

The lens module may be understood to comprise a lens housing and at least one lens arranged within the lens housing. Therein, the lens housing may, for example, enclose the at least one lens circumferentially. The lens housing has a front opening and a rear opening, wherein front and rear may be understood with respect to an axial direction of the lens housing, the lens module and the camera, respectively. In particular, a longitudinal axis of the camera, which is identical to a longitudinal axis of the lens housing and the lens module, is identical or parallel to an optical axis of the at least one lens. The front opening of the lens housing is located at an axial end of the lens housing, which faces away from an imager chip of the camera and the rear opening of the lens housing is located at an opposite axial end of the lens housing, which faces the imager chip.

By heating the lens module, in particular the lens housing, it is heated via the thermal connection between the heater element and the lens module, in particular the lens housing, via the lens holder body. By heating the lens housing also the at least one lens is effectively heated. Therefore, built up ice on the lens and/or the lens housing may be removed by the heating.

The lens holder body is located at the rear end and at the rear opening of the lens housing. The lens holder body may, in particular, be used for connecting the lens module to the vehicle. Apart from the lens housing and the lens holder body, the camera may comprise one or more further components, in particular mounting components or housing components, for mounting the camera and the lens module to the vehicle. For example, the camera may comprise a rear housing body, which is connectable to the vehicle and connected to the lens holder body such that the lens holder body is arranged between the rear housing body and the lens module or between the rear housing body and the lens housing, respectively. The lens holder body being mechanically connected to the lens module may be understood such that the lens holder body is mechanically connected, for example screwed or clamped, to the lens housing.

The heater element being arranged at the surface facing away from the lens module may be understood such that the heater element is attached to or fixed to or fastened to the surface. For example, the heater element may be glued by an adhesive material, for example a pressure sensitive adhesive, to the surface. However, also other types of adhesives may be used. Alternatively, the heater element may be pressed onto the surface by means of a further component or housing component of the camera. In other words, it is possible that the heater element is fastened to the surface by a material bond (German: “Stoffschluss”), but this is not necessarily the case in every embodiment.

The heater element is designed as an electrical heater element and may produce the heat itself when electric current is supplied to the heater element. For example, the heater element may be implemented as a resistive heater element.

The heat, which is originally generated in or at the heater element, is then transferred via the thermal connection between the heater element and the lens module, in particular the lens housing, to the lens module. In particular, the heat is transferred from the heater element to the lens holder body via the surface and from the lens holder body to the lens module, in particular to the lens housing and from the lens housing to the at least one lens. Therein, there may be further intermediate components between the heater element and the lens holder body, which contribute to the heat transfer. In particular, the heat transfer occurs via heat conduction, in particular exclusively or essentially exclusively by heat conduction, also denoted as thermal conduction. In other words, heat transfer via convection or radiation does not play a significant role for heating the lens module by means of the heater element or is not involved in the heating at all.

The heater element being thermally connected to the lens module via the lens holder body may, in particular, be understood such that the thermal conductivity or conduction is sufficient according to a predefined heating requirement for heating the lens module. The heating requirement may, for example, be given in terms of a minimum temperature increase at a predefined position at the lens module and at given and predefined environmental conditions, in particular at a predefined external temperature, which has to be achievable by the heating element. For example, further environmental conditions may be predefined in this context such as an air humidity or an air flow. It may, for example, be specified that the thermal connection is sufficient if the heater element may heat the predefined position at the lens module by at least X° C. at an environmental temperature of Y° C. Optionally, also a maximum time for achieving the heating may be specified. For example, X may be chosen in the order of 1 to 20° C., for example 8 to 12° C. Y may, for example, be chosen between −15 and 0° C., for example between −10 and −6° C. Alternatively, a minimum heat transfer rate achievable by the heating element from the heating element to the specific predefined point at the lens module may be specified.

When designing an actual implementation of the camera, the thermal connection may be tuned by choosing the respective materials of the lens holder body and the lens housing as well as the connection technology to connect the lens housing to the lens holder body. According to the concrete requirements, different choices may be possible. Preferably, the lens holder body and/or the lens housing may contain a metal material, such as aluminum, or consist or predominantly consist of the metal material. Furthermore, for a given thermal conductivity, the size and heating power of the heater element may be further tuned in order to achieve the requirements.

According to the invention, the effort for electrically contacting the heating element may be reduced since the heating element is placed remotely from the lens module and the at least one lens. Further electronic components, such as the imager chip or driving components or evaluation components, may be placed on a circuit board of the camera, which is also located on a side of the lens holder body opposite to the lens module. Thus, the distance between these further electronic components and the heater element may be particularly small in a camera according to the invention.

The power supply for the heater element may be located on the circuit board as well or may be located externally to the camera and connected to the heater element via the circuit board. Thus, an electrical connection is only necessary between the circuit board and the heater element and can therefore be particularly short and simple. In particular, the heater element may be located in the immediate environment of the circuit board. Furthermore, while the lens module may be in principle movable with respect to the circuit board or other housing components of the camera, the heater element and the lens 10 holder body may be at a fixed position with respect to the circuit board. Therefore, the electrical connection between the heater element and the circuit board may be particularly simple.

Furthermore, experiments have shown that a design as described with respect to the invention, a significant heating of the lens module and the at least one lens may be achieved via the thermal connection from the heater element to the lens module via the lens holder body in sufficiently short time.

According to several implementations of the camera according to the invention, the camera comprises the circuit board and the circuit board is arranged at a side of the lens holder body facing away from the lens module. The circuit board comprises supply circuitry for supplying electrical current to the heater element to heat the heater element. The heater element is electrically connected to the supply circuitry.

The circuit board is not necessarily connected to the lens holder body or to the surface at which the heater element is arranged. However, one side of the circuit board may face the heater element.

The supply circuitry may comprise a power source, in particular a current source or a voltage source, to supply the electrical current to the heater element. However, in other implementations, the supply circuitry may be connected to an external power source, which is arranged external to the circuit board and/or external to the camera. The power source may then supply the electrical current indirectly to the heater element via the supply circuitry. In the simplest case, the supply circuitry consists of electrical connections to connect the heater element and the external power supply to each other.

According to several implementations, the heater element is arranged between the circuit board and the lens holder body.

In particular, the circuit board is mounted with respect to the lens holder body such that a space is formed between the circuit board and the lens holder body. The heater element is arranged within the space at the surface of the lens holder body. In particular, a space may also be formed between the heater element and the circuit board. An electrical connection between the supply circuitry and the heater element may be arranged in the space between the heater element and the circuit board. In particular, the space between the heater element and the circuit board may be particularly small, for example between 1 mm and 10 mm, for example between 1 mm and 5 mm. Therefore, the electrical connection may be implemented in a particularly simple way. For example, a rigid electric connector may be used for connecting the supply circuitry to the heater element.

According to several implementations, the supply circuitry comprises a supply contact and the heater element comprises a heater contact. The camera comprises a connector element, which connects the heater contact electrically to the supply contact.

The heater contact and/or the supply contact may, for example, be implemented as contact pads at the heater element and the circuit board, respectively.

Analogously, the supply circuitry may comprise a further supply contact, the heater element may comprise a further heater contact and the camera may comprise a further connector element, which connects the further heater contact electrically to the further supply contact.

The electrical current supplied by the supply circuitry may then flow from the supply contact via the connector element and the heater contact through the heater element and from the further heater contact via the further connector element and the further supply contact back to the supply circuitry or the other way around.

The connector element may, for example, be designed as a spring connector. The same holds for the further connector element. In such implementations, no wires are necessary to contact the heater element to the supply circuitry, which results in a particularly robust and simple design.

According to several implementations, the heater element is designed as a resistive heater element.

For example, the heater element may comprise a flexible sheet heater. For example, the heater element may comprise a heating wire or another conductive structure, for example an etched foil or an etched conducting path on a flexible circuit board, et cetera. The heating wire or other conductive structure may be embedded in an electrically non-conductive material forming a sheet, for example a flexible sheet, such as a silicone rubber material, a polyimide, et cetera. The heater element may also comprise a flexible circuit board covered with an electrically insulating material.

Such heating elements have the advantage that they require particularly little space between the lens holder body and the circuit board. They also may be attached to the lens holder body in a particularly simply way, for example by pressing it against the surface or by gluing it on the surface with an adhesive. On the other hand, such heating elements are available in various geometrical shapes and with sufficient heating power to fulfill said requirements in the camera.

According to several implementations, the camera comprises a rear housing body, which is connected to the lens holder body. The rear housing body and the lens holder body together define an assembly space and the heater element is arranged completely inside the assembly space.

In particular, the rear housing body is arranged on the side of the lens holder body facing away from the lens module. The assembly space is separated from the environment of the camera by the rear housing body and/or the lens holder body. The circuit board may also be arranged inside of the assembly space, in particular completely inside the assembly space. The rear housing body may comprise an opening for a connector cable to connect the circuit board to the motor vehicle, in particular to an electronic control unit, ECU, of the motor vehicle.

In such implementations, the heater element and, in particular, the circuit board may be protected effectively from external or environmental influences such as pollution, soiling, humidity, et cetera.

According to several implementations, the lens holder body comprises a metal material or consists of the metal material, wherein the metal material comprises or forms the surface at which the heater element is arranged. The thermal connection of the heater element to the lens module is established at least in part by the metal material.

The metal material may for example comprise or consist of aluminum or an aluminum alloy, which allows for a particularly high heat conduction rate and, at the same time, a low weight of the lens holder body and a high mechanical stability.

The lens housing may comprise a further metal material and the heater element is thermally connected to the at least one lens via the lens holder body and the further metal material, in particular via the metal material and the further metal material.

The further metal material may also comprise or consist of aluminum or an aluminum alloy. In particular, the lens housing may consist of the further metal material.

According to several implementations, the lens housing comprises an external thread and the lens holder body comprises an internal thread. The lens holder body is fastened to the lens housing via the internal thread and the external thread.

In alternative implementations, the lens housing comprises the internal thread and the lens holder body comprises the external thread.

By fastening the lens holder body to the lens housing via the internal and the external thread, a particularly good heat transfer may be achieved due to the increased surface of the connection between the lens housing and the lens holder body.

According to several implementations, the lens housing comprises the rear opening, which faces the lens holder body, wherein the optical axis of the at least one lens passes through the rear opening. The lens holder body comprises a through hole, which is aligned with the rear opening and the heater element extends annularly around the through hole.

The through hole being aligned with the rear opening means, in particular, that the optical axis passes through the rear opening and also through the through hole and through the annular shape formed by the heater element. In particular, a center of the through hole may match a center of the rear opening and the optical axis may pass through the centers of the rear opening and the through hole.

In particular, an imager chip, which is for example arranged on a surface of the circuit board facing the heater element, the lens holder body and the lens module, may also be aligned with the optical axis of the at least one lens. Since the heater element extends annularly around the through hole, it does not disturb the optical path of light entering the camera through the at least one lens and hitting the surface of the imager chip.

The camera may also comprise processing or pre-processing circuitry for processing or pre-processing imager signals generated by the imager chip upon the light hitting the active surface of the imager chip.

According to a further aspect of the invention, an electronic vehicle guidance system comprising a camera according to the invention is provided.

An electronic vehicle guidance system may be understood as an electronic system, configured to guide a vehicle in a fully automated or a fully autonomous manner and, in particular, without a manual intervention or control by a driver or user of the vehicle being necessary. The vehicle carries out all required functions, such as steering maneuvers, deceleration maneuvers and/or acceleration maneuvers as well as monitoring and recording the road traffic and corresponding reactions automatically. In particular, the electronic vehicle guidance system may implement a fully automatic or fully autonomous driving mode according to level 5 of the SAE J3016 classification. An electronic vehicle guidance system may also be implemented as an advanced driver assistance system, ADAS, assisting a driver for partially automatic or partially autonomous driving. In particular, the electronic vehicle guidance system may implement a partly automatic or partly autonomous driving mode according to levels 1 to 4 of the SAE J3016 classification. Here and in the following, SAE J3016 refers to the respective standard dated June 2018.

Guiding the vehicle at least in part automatically may therefore comprise guiding the vehicle according to a fully automatic or fully autonomous driving mode according to level of the SAE J3016 classification. Guiding the vehicle at least in part automatically may also comprise guiding the vehicle according to a partly automatic or partly autonomous driving mode according to levels 1 to 4 of the SAE J3016 classification.

The electronic vehicle guidance system may, for example, comprise a control unit, which is configured to generate one or more control signals depending on image data generated by the camera, in particular by the imager chip and/or the processing or pre-processing circuitry. The control signals may be supplied by the control unit to one or more actuators of the motor vehicle to guide the motor vehicle at least in part automatically.

Alternatively or in addition, the electronic vehicle guidance system may comprise a display device, which is configured to display an image depending on the image data generated by the camera to a user of the motor vehicle.

According to a further aspect of the invention, also a motor vehicle comprising an electronic vehicle guidance system according to the invention and/or a camera according to the invention is provided.

According to a further aspect of the invention, also a method for heating a lens module of a camera for a motor vehicle is provided. According to the method, a heater element is arranged at a surface of a lens holder body of the camera, which is mechanically connected to the lens module, wherein the surface faces away from the lens module. The lens holder body is heated by the heater element and heat is transferred from the heated lens holder body to the lens module.

In other words, heat is generated by the heater element and transferred to the lens module via a thermal connection established at least in part by the lens holder body and, in particular, to at least one lens of the lens module.

Further implementations of the method according to the invention follow directly from the various implementations of the camera according to the invention, the electronic vehicle guidance system and the motor vehicle according to the invention, and vice-versa. In particular, a camera according to the invention may carry out or may be used to carry out a method according to the invention or carries out such a method.

Further features of the invention are apparent from the claims, the figures and the figure description. The features and combinations of features mentioned above in the description as well as the features and combinations of features mentioned below in the description of figures and/or shown in the figures may be comprised by the invention not only in the respective combination stated, but also in other combinations. In particular, embodiments and combinations of features, which do not have all the features of an originally formulated claim, are also comprised by the invention. Moreover, embodiments and combinations of features which go beyond or deviate from the combinations of features set forth in the recitations of the claims are comprised by the invention.

In the figures,

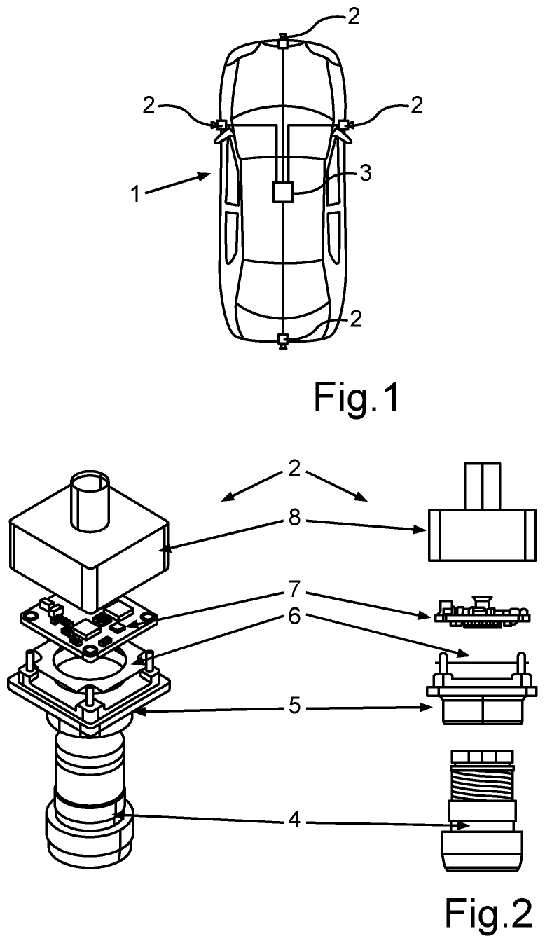

FIG. 1 shows schematically a motor vehicle with an exemplary implementation of a camera according to the invention;

FIG. 2 shows schematically an exploded side view and an exploded perspective view of a further exemplary implementation of a camera according to the invention;

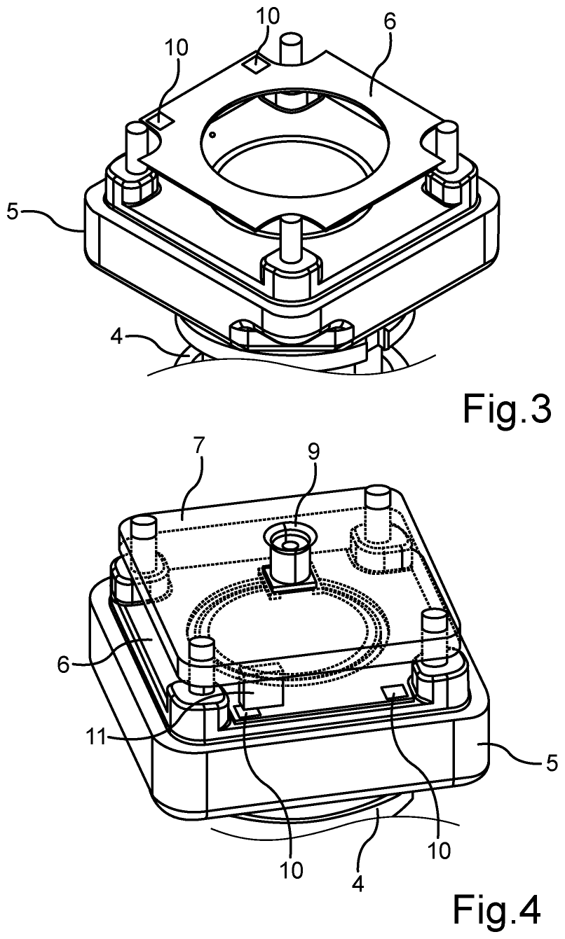

FIG. 3 shows schematically a perspective view of a part of a further exemplary implementation of a camera according to the invention;

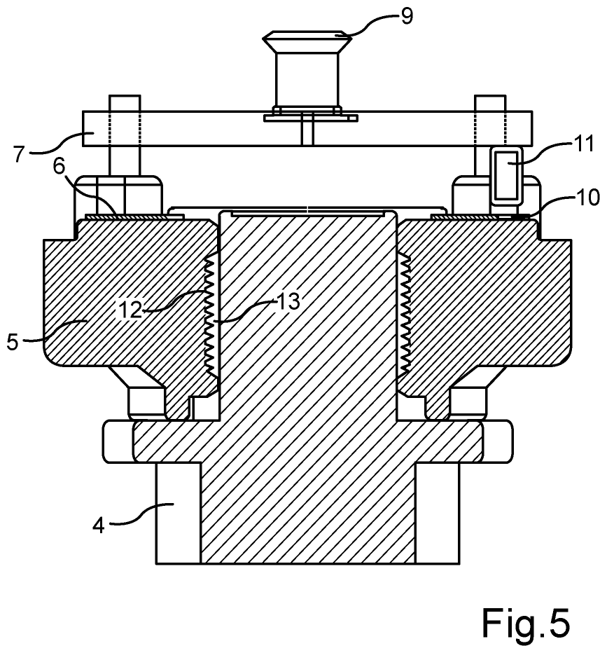

FIG. 4 shows schematically a perspective view of a part of a further exemplary implementation of a camera according to the invention; and

FIG. 5 shows schematically a longitudinal section through a part of a further exemplary implementation of a camera according to the invention.

In the figures, identical or functionally identical elements are provided with the same reference signs.

In FIG. 1, a motor vehicle 1 comprising at least one camera 2, for example a front camera, side cameras and/or a rear camera, which is implemented according to an exemplary embodiment of the present invention is shown in a top view. Here, the motor vehicle 1 is formed as a passenger car. The motor vehicle 1 comprises an electronic vehicle guidance system according to the invention, wherein the camera 2 may be considered as a part of the electronic vehicle guidance system. The electronic vehicle guidance system comprises a control unit 3, which may for example be formed by an electronic control unit, ECU, of the motor vehicle 1.

In the shown example, the motor vehicle 1 comprises four cameras 2, which are arranged distributed at the motor vehicle 1. One of the cameras 2 is arranged in a rear area, one of the cameras 2 is arranged in a front area of the motor vehicle 1 and the remaining two cameras 2 are arranged in respective lateral areas, in particular in vicinities of the wing mirrors. The number and arrangement of the cameras 2 may, however, be different in other examples. Alternatively in in addition one or more cameras according to the invention may be arranged for capturing an interior space or a passenger compartment of the motor vehicle 1.

The camera 2 is, in particular, installed such that it is assembled to a respective individual motor vehicle component. A motor vehicle component may for example be a bumper or an exterior mirror or a side trim. The motor vehicle component may also be a headliner or an interior trim or a cover of a steering wheel center or an interior mirror. The mentioned motor vehicle components are to be considered only as non-limiting examples.

In an embodiment, an environmental region of the motor vehicle 1 may be captured by the camera 2. In case of four cameras 2, the four cameras 2 may preferably be formed identical in construction. In particular, an image sequence or video data can be provided by the camera 2, which describes the environmental region. The video data may be transmitted from the camera 2 to the control unit 3. By means of the control unit 3, a display device (not shown) of the motor vehicle 1 may be controlled such that the video data of the camera 2 can be displayed to a user of the motor vehicle 1. Thus, the electronic vehicle guidance system may operate as a driver assistance system for assisting a driver of the motor vehicle 1 in driving the motor vehicle 1. Alternatively or in addition, the control unit 3 may process the video data and generate at least one control signal for one or more respective actuators (not shown) of the motor vehicle 1, which may control the motor vehicle 1 automatically or in part automatically based on the control signals.

FIG. 2 shows an exploded perspective view on the left and a corresponding exploded side view on the right, of an exemplary implementation of a camera 2 according to the invention, as it may be used in a motor vehicle 1 or the corresponding electronic vehicle guidance system described with respect to FIG. 1, for example.

The camera 2 comprises a housing, which includes a rear housing body 8 connected to a lens holder body 5 such that an assembly space is formed within a region enclosed by the rear housing body 8 in combination with the lens holder body 5.

The camera 2 further comprises a lens module with a lens housing 4, which is attached to the lens holder body 5 on a side opposite to the rear housing body 8 and the assembly space. In particular, the lens housing 4 may comprise an external thread 13 and the lens holder body 5 may comprise an internal thread 12 and the lens holder body 5 may be fastened to the lens housing 4 by means of the internal thread 12 and the external thread 13 as depicted schematically in the longitudinal cross-section view of FIG. 5. In alternative implementations, the lens holder body 5 may comprise an external thread and the lens housing 4 may comprise an internal thread to connect the external thread of the lens holder body 5.

For example, the lens housing 4 may comprise a hollow shaft, which has, for example, an approximately cylindrical inner shape and encloses one or more optical lenses of the lens module and the camera 2, respectively. The optical axis of the lenses is, in particular, parallel or identical to a longitudinal axis of the hollow shaft. The longitudinal axis of the hollow shaft may therefore be considered as the longitudinal axis of the lens module and the longitudinal axis of the camera 2, respectively. It will be denoted as longitudinal axis in the following, if not denoted otherwise. For example, the external thread 13 may be arranged on an outer side of the hollow shaft.

The lens holder body 5 may comprise a through hole aligned with the hollow shaft of the lens housing 4 to allow for light entering the camera 2 via the lenses and the lens housing 4 through the hollow shaft and the through hole into the assembly space. Within the assembly space, a circuit board 7 of the camera 2 may be arranged, which carries an imager chip (not shown) of the camera 2, which is also aligned with the hollow shaft, the through hole and the optical axis as well as the longitudinal axis, respectively. Therefore, light entering the camera and entering, through the hollow shaft and the trough hole, the assembly space may hit an active optical surface of the imager chip. The imager chip generates respective imager signals, which may be transmitted to the control unit 3 via an opening in the rear housing body 8 and the corresponding cable connection (not shown).

Alternatively, the circuit board 7 may comprise pre-processing circuitry, such as a digital signal processor, DSP, a microcontroller, a graphics processing unit, GPU, et cetera, to pre-process the imager signals and to provide the pre-processed imager signals to the control unit 3. The control unit 3 may then generate the video data depending on the imager signals or the pre-processed imager signals, respectively.

The lens holder body 5 has a surface, which faces away from the lens housing 4 and faces the rear housing body 8, the circuit board 7 and the assembly space, respectively. According to the through hole of the lens holder body 5, the surface has an opening, for example a circular opening. The camera 2 comprises an electric heater element 6, in particular a resistive heater element.

The heater element 6 may for example be implemented as a flexible heater foil, which is arranged on the surface of the lens holder body 5. In particular, the heater element 6 may be arranged in an annular manner around the opening and the through hole of the lens holder body 5. The heater element 6 may for example be attached to the surface by mechanical pressure, which is exerted on the heater element 6 by means of the rear housing body 8 or by another component of the camera 2. For example, clamps or spring elements may be used to press the heater element 6 on the surface. Alternatively or in addition, the heater element 6 may be fastened to the surface of the lens holder body 5 by means of an adhesive material. For example, a pressure-sensitive adhesive may be used, which allows for a simple assembly of the camera during production since no specific hardening steps, such as UV-hardening or thermal hardening, must be carried out. However, also other types of adhesives may be used.

The lens holder body 5 as well as the lens housing 4 contain a material with a large heat conductivity, in particular a metal, for example aluminum or an aluminum alloy. For example, the lens holder body 5 and/or the lens housing 4 may consist of or predominantly consist of the material. Therefore, since the lens holder body 5 is mechanically connected to the lens housing 4, heat, which is generated by the heater element 6 when it is supplied with electrical current, is transferred from the heater element 6 to the lens holder body 5 and, via the mechanical connection of the lens holder body 5 and the lens housing 4, to the lens housing 4. Therefore, the lens module and, in particular, the lens housing 4 as well as the at least one lens may be heated indirectly by means of the heater element 6. To this end, the heat generated by the heater element 6 is transferred via the lens holder body 5 by thermal conduction via a corresponding thermal connection between the heater element 6 and the lens housing 4.

In case the lens holder body 5 is connected to the lens housing 4 via the internal and the external thread 12, 13, the large surface generated by the threads 12, 13 and the resulting high degree of thermal conductivity leads to a particularly fast and/or efficient heating.

The circuit board 7 comprises supply circuitry for supplying the electrical current to the heater element 6. To this end, the circuit board 7 may carry a corresponding power source or circuitry, in particular conductive paths or wires, for connecting the heater element 6 to an external power source. The external power source may, for example, be located in the control unit 3 or may be connected to the camera 2 via the control unit 3.

As shown in FIG. 3 and FIG. 4 schematically, the heater element 6 may comprise two contact pads 10 on a side facing the circuit board 7 and the camera 2 may comprise two respective spring connectors 11, which connect each of the contact pads 10 to a corresponding supply contact (not shown) of the supply circuitry on the circuit board 7. It is noted that in FIG. 4 only one of the two spring connectors 11 is shown. In this way, the electrical connection between the heater element 6 and the circuit board 7, in particular the supply circuitry and the power source, is particularly simple and robust against mechanical disturbances or other external influences.

FIG. 4 and FIG. 5 further show a connector 9 for connecting a video cable between the camera 2 and the control unit 3.

By locating the heater element 6 in the assembly space remotely from the lens module and the lens housing 4, in particular remotely from the one or more lenses, the effort for connecting the heater element 6 electrically via the circuit board 7 is minimized. Nevertheless, due to the thermal connection of the heater element 6 via the lens holder body 5 and the lens housing 4, the lens module and the at least one lens may be efficiently heated in a short period of time to remove ice build-up or steamed up surfaces of the at least one lens to improve availability, functionality and safety of the camera 2.

1. A camera for a motor vehicle,
the camera comprising:
a lens module,
a lens holder body, which is mechanically connected to the lens module, and
an electrical heater element for heating the lens module,
wherein the heater element is arranged at a surface of the lens holder body facing away from the lens module; and
wherein the heater element is thermally connected to the lens module via the lens holder body.

2. The camera according to claim 1,
wherein the camera comprises a circuit board, which is arranged at a side of the lens holder body facing away from the lens module;
wherein the circuit board comprises supply circuitry for supplying electrical current to the heater element; and
wherein the heater element is electrically connected to the supply circuitry.

3. The camera according to claim 2,
wherein the heater element is arranged between the circuit board and the lens holder body.

4. Camera according to claim 2,
wherein the supply circuitry comprises a supply contact, the heater element comprises a heater contact and the camera comprises a connector element, which connects the heater contact electrically to the supply contact.

5. The camera according to claim 4,
wherein the connector element is configured as a spring connector.

6. The camera according to claim 1,
wherein the heater element is configured as a resistive heater element.

7. The camera according to claim 1,
wherein the camera comprises a rear housing body, which is connected to the lens holder body;
wherein the rear housing body and the lens holder body together form an assembly space; and
wherein the heater element is arranged completely inside the assembly space.

8. The camera according to claim 1,
wherein the lens holder body comprises a metal material forming the surface at which the heater element is arranged; and
wherein the thermal connection of the heater element to the lens module is formed at least in part by the metal material.

9. The camera according to claim 1,
wherein the lens module comprises a lens housing and at least one lens arranged within the lens housing.

10. The camera according to claim 9,
wherein the lens housing comprises a further metal material; and
wherein the heater element is thermally connected to the at least one lens via the lens holder body and the further metal material.

11. The camera according to claim 9,
wherein the lens housing comprises an external thread and the lens holder body comprises an internal thread or the lens housing comprises an internal thread and the lens holder body comprises an external thread; and
wherein the lens holder body is fastened to the lens housing via the internal thread and the external thread.

12. The camera according to claim 9,
wherein the lens housing comprises a rear opening facing the lens holder body,
wherein an optical axis of the at least one lens passes through the rear opening;
wherein the lens holder body comprises a through hole which is aligned with the rear opening; and
wherein the heater element extends annularly around the through hole.

13. The camera according to claim 1,
wherein the camera comprises an imager chip, which is mounted to the circuit board.

14. An electronic vehicle guidance system comprising a camera according to claim 1.

15. A method for heating a lens module of a camera for a motor vehicle,
the method comprising:
arranging a heater element at a surface of a lens holder body, which is mechanically connected to the lens module,
wherein the surface faces away from the lens module; and
beating the lens holder body by the heater element,
wherein heat is transferred from the heated lens holder body to the lens module.
